(19) United States
(12) Patent Application Publication
(10) Pub. No.: US 2005/0111228 A1
(43) Pub. Date: May 26, 2005

(54) Demountable lampshade

(76) Inventor: Teng Li Chen, Yang City (CN)

Correspondence Address: Yi-Wen Tseng, 509 ROOSEVELT BLVD. #D306, FALLS CHURCH, VA, 22044, US

(21) Appl. No.: 10/720,156

(22) Filed: Nov. 25, 2003

(51) Int. Cl. F21V 1/06

(52) U.S. Cl. 362/352

(57) ABSTRACT

A demountable lampshade includes a plurality of shade piece, a connecting base and a plurality of mounting fixtures. Each shade piece has a frame body with a receiving portion formed thereon. The connecting base has a plurality of projecting bars. Each projecting bar has a connecting portion at the end to connect with the receiving portion of each shade piece. The mounting fixtures are used to mount the shade pieces with each other to form a lampshade structure. Accordingly, the lampshade structure can be rapidly and easily disassembled for conveniently storing or transporting.

### BACKGROUND OF THE INVENTION

The present invention relates generally to a lampshade structure and, more particularly, to a demountable lampshade for various lamps, such as the desk lamps, table lamps and floor lamps etc, which has a delicate structure for assembly and can be easily disassembled for storage.

The conventional lampshade structure includes a frame body and a shade body embracing the frame body. In order to have sufficient structural strength and ensure safety, the conventional frame body is generally made of an upper collar, a lower collar much larger than the upper collar, and a plurality of ribs welded to the upper and the lower collars to form the frame body. Such frame body has rigid structure. However, after welded, the frame body cannot be disassembled and will occupy much room. Therefore, when storing or transporting a large amount of products, very much room will be occupied to lead to great inconvenience in storage and transportation. This results in increased cost and is not economic.

Accordingly, the applicant has invented “Rotabaly collapsible lampshade” applied for China patent application No. ZL02248113.3, which includes three shade bodies, a retractable base and three clamping fixtures. The lampshade can be folded by rotating the retractable base. However, because this structure is more complicated, the manufacturing expense can not be reduced to meet the requirement of regular-priced lamp equipments.

Therefore, there exist inconvenience and drawbacks for practically application of the above-mentioned conventional lampshade structure. There is thus a substantial need to provide an improved lampshade that resolves the above drawbacks and can be used more conveniently and practically.

### BRIEF SUMMARY OF THE INVENTION

The object of the present invention is to provide a demountable lampshade which can be rapidly and easily disassembled.

Another object of the present invention is to provide a demountable lampshade which can be disassembled into multiple shade pieces to be stacked together for convenient storage and transportation.

In order to achieve the above-mentioned objects, a demountable lampshade including a plurality of shade pieces, a connecting base and a plurality of mounting fixtures is disclosed. Each shade piece has a frame body with a receiving portion formed thereon. The connecting base has a plurality of projecting bars. Each projecting bar has a connecting portion at the end to connect with the receiving portion of each shade piece. The mounting fixtures are used to mount the shade pieces with each other to form a lampshade structure.

These and other objectives of the present invention will become obvious to those of ordinary skill in the art after reading the following detailed description of preferred embodiments.

It is to be understood that both the foregoing general description and the following detailed description are exemplary, and are intended to provide further explanation of the invention as claimed.

### BRIEF DESCRIPTION OF THE DRAWINGS

These, as well as other features of the present invention, will become more apparent upon reference to the drawings wherein:

FIG. 1 shows a locally exploded view of a demountable lampshade according to a first preferred embodiment of the present invention;

FIG. 2 shows a partially assembling view of the first preferred embodiment;

FIG. 3 shows a perspective view of the assembly of the first preferred embodiment;

FIG. 4 shows an exploded view of a demountable lampshade according to a second preferred embodiment of the present invention;

FIG. 5 shows a perspective view of the assembly of the second preferred embodiment;

FIG. 6 shows a partially assembling view of a demountable lampshade according to a third preferred embodiment of the present invention; and

FIG. 7 shows a partially assembling view of a demountable lampshade according to a fourth preferred embodiment of the present invention.

### DETAILED DESCRIPTION OF THE INVENTION

Reference will now be made in detail to the preferred embodiments of the present invention, examples of which are illustrated in the accompanying drawings. Wherever possible, the same reference numbers are used in the drawings and the description to refer to the same or like parts.

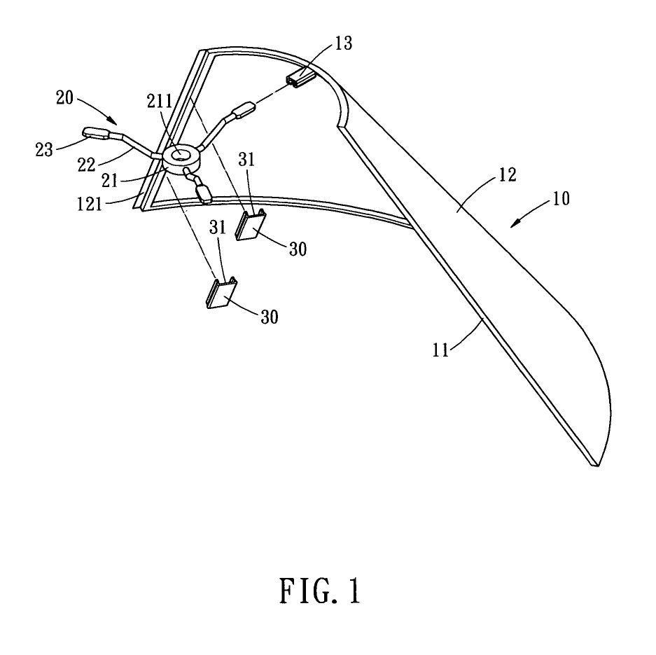

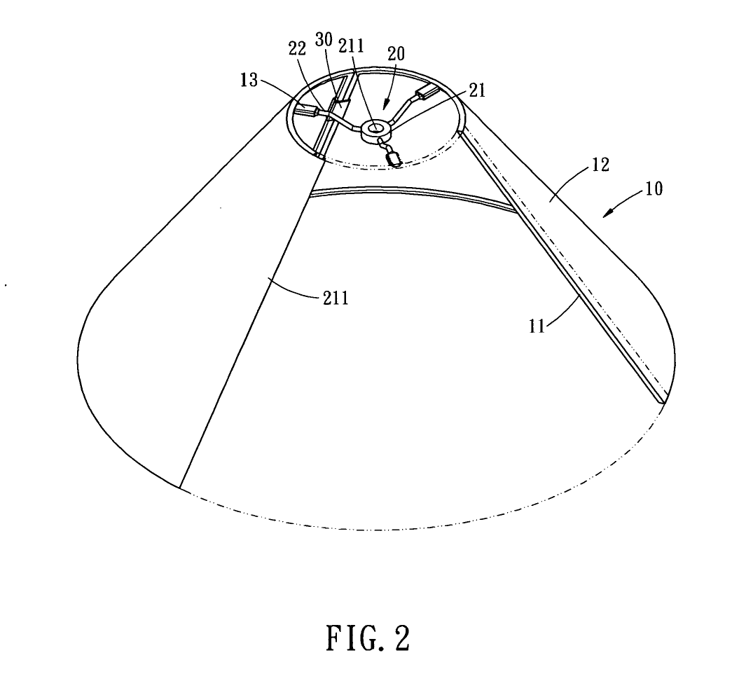

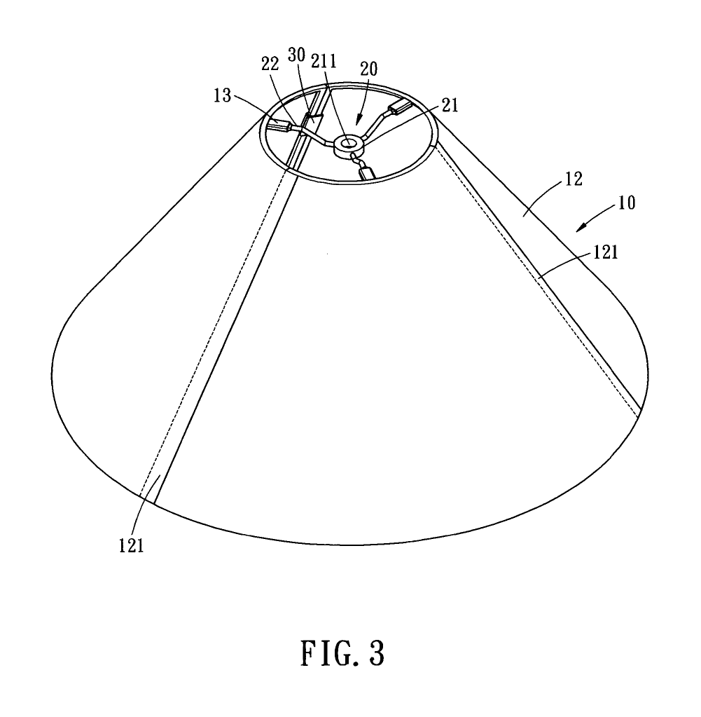

FIGS. 1 to 3 show the locally exploded view, partially assembling view and perspective view of a demountable lampshade structure, respectively, according to the first preferred embodiment of the invention. The lampshade includes at least two shade pieces 10, a connecting base 20 and a plurality of mounting fixtures 30.

The number of the fanlike shade pieces 10 can be two, three or four etc. In this preferred embodiment, there are three identical shade pieces 10 to be mounted with each other to form the lampshade structure. The shade piece 10 includes a frame body 11 and a shade body 12 made of plastic material to embrace the frame body 11. The shade body 12 is outstretched at one side of the frame body 11 to form an overlapping cover 121 on the other shade piece 10 while two shade pieces are mounted together. Further, the shade piece 10 has a receiving portion 13 formed on the frame body 11. The receiving portion 13 can be a socket portion or a plugging portion to connect with the connecting base 20. In this preferred embodiment, receiving portion 13 is a rectangular socket.

The connecting base 20 includes a base body 21 and a plurality of projecting bars 22 integratedly formed thereon. The base body 21 can be formed as a plate or a cylinder. As in this preferred embodiment, the base body 21 is a cylinder with a through hole 211 formed in the center for furnishing to a stand of the lamp. The amount of the projecting bars 22 is equal to the amount of the shade pieces 10. Each projecting bar 22 has a connecting portion 23 at the end to connect with the receiving portion 13 of each shade piece 10. The connecting portion 23 can be a plugging portion or a socket portion with respect to the receiving portion 13; therefore, the connecting portion 23 of this preferred embodiment is a rectangular plug. As such, a demountable connection of the receiving portion 13 and the connecting portion 23 is achieved.

The mounting fixtures 30 of this preferred embodiment is formed by bending a resilient metal plate to provide a slot 31 therein. The adjacent frame bodies 11 of two assembling shade pieces 10 are secured in the slot 31. Due to the resilience of the metal plate, the mounting fixtures 30 can fixedly clamp the shade pieces 10 with each other to construct the lampshade structure after the connecting portions 23 of the connecting base 20 are connected to the receiving portions 13 of the shade pieces 10.

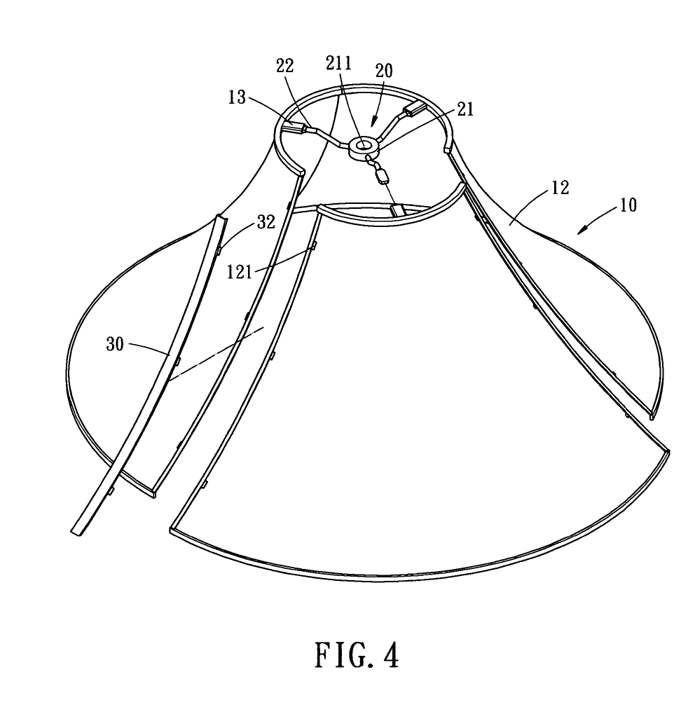

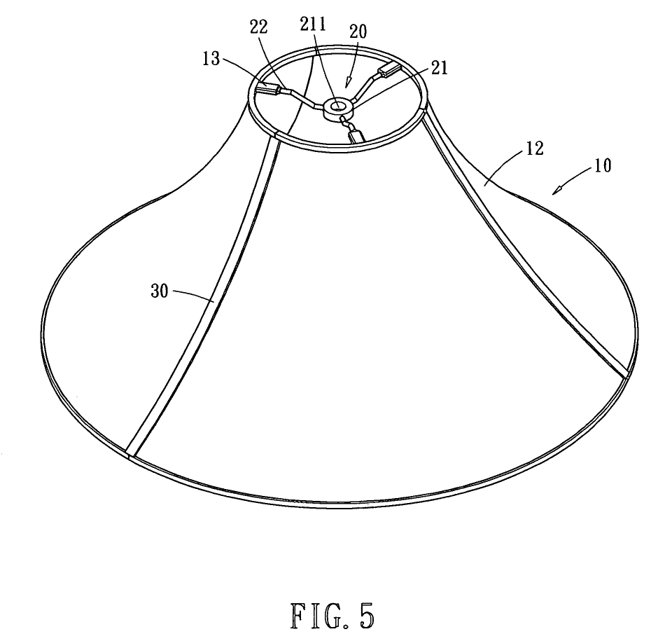

Please refer to FIGS. 4 and 5, which show an exploded view and a perspective view of the second preferred embodiment, respectively. In this embodiment, the shade body 12 of each shade piece 10 has a curving surface. There are a plurality of fixing holes 121 symmetrically formed on the shade body 12 near the frame body 11. The mounting fixture 30 is formed as a long strip with a plurality of clamping portions 32 corresponding to the fixing holes 121 of the shade body 12. As such, due to the engagement of clamping portions 32 and the fixing holes 121, the mounting fixtures 30 can fixedly clamp the shade pieces 10 with each other to construct the lampshade structure.

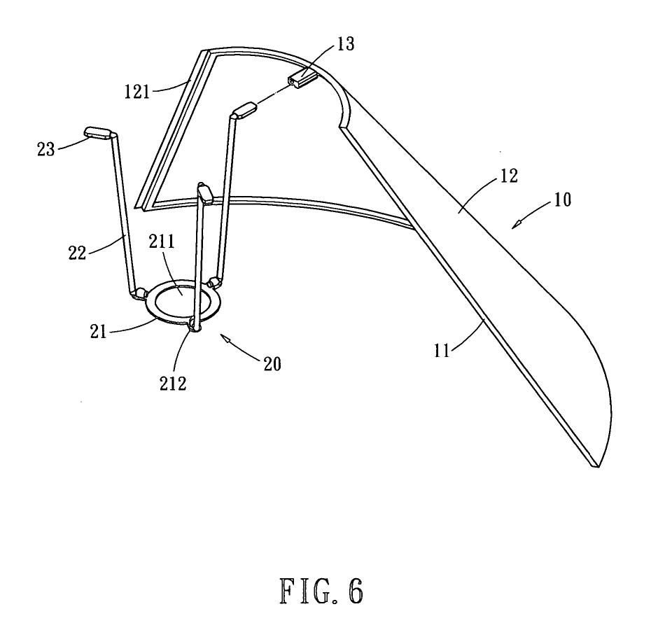

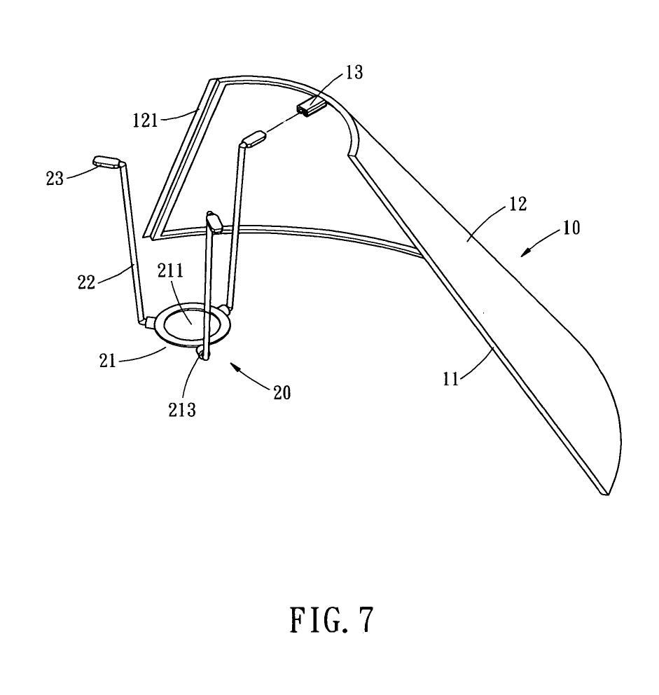

Furthermore, FIGS. 6 and 7 both show a partially assembling view of the demountable lampshade according the third and fourth embodiments of the present invention. In these embodiments, the base body 21 of the connecting base 20 is a metal plate. There is also a circular hole 211 formed in the center for furnishing to the stand of the lamp. As shown in FIG. 6, the base body 21 has a plurality of protrusions 212 for the respective projecting bars 22 to be welded thereon so as to obtain the connecting base 20. Next, as shown in FIG. 7, the base body has a plurality of rivet holes 213 for the respective projecting bars 22 to be riveted therein.

According to the lampshade structure of the present invention, it provides at least the advantages as follows.

1. The demountable connection of the connecting base and the shade pieces can provide a rapid and easy assembly and disassembly.

2. The disassembled multiple shade pieces can be stacked together to reduce the occupying room for convenient storage and transportation.

3. The mounting fixtures can either clamp the multiple shade pieces from inside of the assembly to provide a neat and smooth appearance, or clamp outside for conveniently assembling.

It will be apparent to those skilled in the art that various modifications and variations can be made to the present invention without departing from the scope or spirit of the invention. In view of the foregoing, it is intended that the present invention cover modifications and variations of this invention provided they fall within the scope of the invention and its equivalent.

1. A demountable lampshade, comprising:
a plurality of shade piece, each including a frame body with a receiving portion formed thereon;
a connecting base including a plurality of projecting bars, each projecting bar having a connecting portion at the end to connect with the receiving portion of each shade piece; and
a plurality of mounting fixtures for mounting the shade pieces with each other to form a lampshade structure.

2. The demountable lampshade of claim 1, wherein the shade piece has a fanlike shape.

3. The demountable lampshade of claim 1, wherein the shade piece further includes a shade body embracing the frame body.

4. The demountable lampshade of claim 3, wherein the shade body is made of plastic material.

5. The demountable lampshade of claim 3, wherein the shade body is outstretched at one side of the frame body to form an overlapping cover on the other shade piece while two shade pieces are mounted together.

6. The demountable lampshade of claim 3, wherein the shade body forms a plurality of fixing holes, and the mounting fixture has a plurality of clamping portions engaging with the fixing holes to mount two shade pieces together.

7. The demountable lampshade of claim 1, wherein a connection of the receiving portion of the shade piece and the connecting portion of the connecting base is demountable.

8. The demountable lampshade of claim 7, wherein the receiving portion of the shade piece is a socket portion or a plugging portion.

9. The demountable lampshade of claim 1, wherein the connecting base further includes a base body integratedly formed with the projecting bars.

10. The demountable lampshade of claim 9, wherein the base body is a cylinder or a plate.

11. The demountable lampshade of claim 1, wherein the connecting base further includes a base body fixedly furnished with the projecting bars.

12. The demountable lampshade of claim 11, wherein the base body is a cylinder or a plate.
